(19) United States
(12) Patent Application Publication
(10) Pub. No.: US 2007/0093620 A1
(43) Pub. Date: Apr. 26, 2007

(54) Powder coating and process for the preparation of thin layers in the manufacture of printed circuit boards

(75) Inventors: Christoph Rickert, Reinach (CH); Jurgen Kress, Basel (CH); Sandro Cicchetti, Magden (CH)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Atotech Deutschland GMBH, Berlin (DE)

(21) Appl. No.: 10/550,468

(22) PCT Filed: Mar. 22, 2004
(86) PCT No.: PCT/EP04/03001

§ 371 Date: Aug. 18, 2006

(30) Foreign Application Priority Data
Mar. 26, 2003 (DE) 103 13 555.3
Mar. 26, 2003 (DE) 103 13 556.1

(51) Int. Cl. C08L 63/04

(52) U.S. Cl. 525/523; 525/529; 525/934

(57) ABSTRACT

The invention relates to a powder coating, an aqueous dispersion based on the powder coating, a process for its preparation and a process for the preparation of coating layers on substrates, inter alia for the preparation of multilayer structures. The process does not require the use of any organic solvents.

The invention relates to a powder coating, a process for its preparation and a process for the preparation of coating layers on substrates, in particular, on printed circuit boards.

The preparation of dielectric layers is known per se and is essentially carried out by using dry films, i.e., sheets consisting of several layers.

One of these layers is the not yet fully cured, still reactive resin (B-stage). This is stabilized by a support layer (for example, copper, PET) and is covered on the other side by a protective layer (for example, of PE). The application is carried out in such a way that the protective layer is removed and the remaining sheet is laminated onto a structured printed circuit board. In the case where a PET support layer is used, the support layer of PET is peeled of after heat curing. In variants of this process, a further resin layer, which is already fully cured (C-stage), is present between the reactive resin layer (B-stage) and the support layer. The advantage of this method lies in better control of the minimal layer thickness of the dielectric and in better planarity of the layer at the end of the overall process.

These dry films are described in Charles A. Harper, High Performance Printed Circuit Boards, 1999, McGraw-Hill, Chapter 2. Because of the high reactivity of the resin layer, the material must be stored and shipped at low temperatures (<0° C.) which causes extra costs and requires considerable logistic capabilities. The layer is typically prepared by applying a liquid formulation to the support layer, i.e., the formulation must be capable of being formulated as a liquid. Furthermore, solvent emissions occur upon drying.

The process described above have the disadvantage that certain fillers can be incorporated only with difficulty or not at all. As a general rule, the filler must be capable of being dispersed stably in an organic solvent.

A further disadvantage is the low storage stability of the aforementioned dry films and the necessity to store and ship these at low temperatures.

The object of the invention is to provide a powder coating, a dispersion on the basis thereof, a process for the preparation of the coating or the dispersion and a process for preparing thin coating layers on substrates, in particular, on copper sheet for the preparation of printed circuit boards, which do not have these disadvantages.

All conceivable fillers are to be useable in the powder coating and in the process of the invention.

Furthermore, the use of organic solvents is to be avoided.

Moreover, the use of the powder coating or the process of the invention is to make it possible to prepare thin dielectric coating layers with improved properties on structured or non-structured substrates.

The invention provides a curable powder coating which is obtainable by

(i) mixing
(a) a polymeric binder, an oxazine resin, a cyanate ester or a maleimide,
(b) a hardener or initiator,
(c) a coating additive,
(d) optionally a filler,
(e) optionally a compatibilizing polymer
and optionally further components

(ii) melt extruding the mixture obtained in step (i) and

(iii) milling and sieving the extruded mixture.

According to a preferred embodiment of the invention, the powder coating has a glass transition temperature in the uncured state of at least 20° C., preferably at least 25° C. and more preferably at least 30° C. and has a glass transition temperature in the cured state of at least 150° C., preferably at least 160° C. and more preferably at least 170° C.

Furthermore, the polymeric binder is preferably essentially an epoxy resin which is solid at room temperature. The glass transition temperature of the resin should preferably be at least 25° C.

The powder coating of the invention can preferably also comprise a mixture of epoxy resins. This mixture preferably has a glass transition temperature of >25° C. in the uncured state. Its molecular weight (number average molecular weight) is generally >600.

Suitable epoxy resins for the preparation of the powder coating of the invention are described, for example, in: Clayton A. May (Ed.) Epoxy Resins: Chemistry and Technology, 2nd ed., Marcel Dekker Inc., New York, 1988.

Preferred mixtures of epoxy resins on the basis of bisphenol A and bisphenol A diglycidyl ether. The epoxy equivalent weight of these resins is >300 g/equivalent. Such a resin is, for example, D.E.R. 6508 (available from Dow Chemicals).

Epoxy resins on the basis of bisphenol F and bisphenol S can optionally also be added.

Furthermore, the mixture can comprise multifunctional epoxy resins. The functionality of these resins is >3. Examples for such multifunctional epoxy resins are cresol-novolak epoxy, phenol-novolak epoxy and naphthol-containing multifunctional epoxy resins.

Examples for the aforementioned epoxy resins are bisphenol A epoxy resin such as D.E.R. 667-20, D.E.R. 663UE, D.E.R. 692H, D.E.R. 692, D.E.R. 662E, D.E.R. 6508, D.E.R. 642U-20 (available from Dow Chemicals), cresol-novolak epoxy resins such as Araldite ECN 1299, Araldite ECN 1280 (Vantico), EOCN-103 S, EOCN-104, NC-3000, EPPN 201, EPPN-502 H (Nippon Kayaku), naphthol epoxy resins such as NC 7000-L (Nippon Kayaku) and brominated Epoxy resins such as Araldite 8010 (Vantico), BREN-S (Nippon Kayaku), ESB-400 T (Sumitomo) and Epikote 5051 (Resolution). Moreover, modified epoxy resins can also be used. Such modifications are, for example, the use of chain reaction terminating agents to control the molecular weight, so-called “high-flow” resins, and the use of multi-functional monomers to prepare branched resins.

A particularly preferred powder coating of the invention comprises, as component (a), about 50-90 wt.-% of epoxide and about 5-20 wt.-% of cyanate ester, as component (b), about 0.5-5 wt.-% of dicyandiamide and about 0.1-2 wt.-% of 2-phenyl-imidazole, for example about 85 wt.-% of epoxide, 10 wt.-% of cyanate ester, about 2 wt.-% of dicyandiamide as hardener and about 1 wt.-% of 2-phenylimidazole as initiator.

As mentioned above, apart from the epoxy resins, cyanate esters can also be used as polymeric binders. In the preparation of the powder coating of the invention, these can be used both in monomeric form as well as in the form of oligomers or prepolymers.

Suitable cyanate esters are bifunctional cyanate esters, such as BADCy, Primaset Fluorocy, Primaset MethylCy, or multifunctional cyanate esters, such as Primaset BA-200, Primaset PT 60, Primaset CT 90, Primaset PT 30. All of the aforementioned bifunctional and multifunctional cyanate esters are available from Lonza, Basel, Switzerland.

Especially preferred cyanate esters are BADCy and its prepolymers (e.g. Primaset BA-200).

Apart form the cyanate esters, the component (a) can also comprise 1-oxa-3-aza-tetralin-containing compounds (oxazine resins). In the preparation of the powder coating of the invention, these are also initially employed in monomeric form.

Preferred oxazine resins are those which are obtained either by reacting bisphenol A with aniline and formaldehyde or by reacting 4,4′-diaminodiphenyl methane with phenol and formaldehyde. Further examples may be found in WO 02/072655 and EP 0 493 310 A1 as well as in WO 02/055603 and the Japanese patent applications JP 2001-48536, JP 2000-358678, JP 2000-255897, JP 2000-231515, JP 2000-123496, JP 1999-373382, JP 1999-310113 and JP 1999-307512. Further examples may be found in Macromolecular Chemistry, Macromolecular Symposia (1993), 74 (4th Meeting on Fire Retardant Polymers, 1992), 165-71, EP 0 493 310 A1, EP 0 458 740 A1, EP 0 458 739 A2, EP 0 356 379 A1 and EP 0 178 414 A1.

The maleimides used in the preparation of the powder coating of the invention are also known per se to the skilled person and are described, for example, in Shiow-Ching Lin, Eli M. Pearce, High-Performance Thermosets, Carl Hanser Verlag, Munich 1994, Chapter 2.

The component (b) of the resin composition of the invention comprises a hardener or initiator. Such hardeners and initiators are known per se to the skilled person and comprise latent hardeners with low activity at room temperature, such as phenolic hardeners, such as D.E.H. 90, D.E.H. 87, D.E.H. 85, D.E.H. 84, D.E.H. 82 (available from Dow Chemicals, US), dicyandiamide or derivatives thereof, such as Dyhard OTB, Dyhard UR 200, Dyhard UR 300, Dyhard UR 500, Dygard 100, Dyhard 100 S, Dyhard 100 SF and Dyhard 100 SH (available from Degussa, Germany), bisphenol A, acid anhydrides, such as phthalic acid anhydride, tetrahydrophthalic acid anhydride, trimellitic acid anhydride, pyromellitic acid anhydride, hexahydrophthalic acid anhydride, HET-acid anhydride, dodecenyl succinic acid anhydride, bicyclo[2.2.1]hept-5-en-2,3-dicarboxylic acid anhydride, aromatic and aliphatic amines, such as diaminodiphenylsulfone, diaminodiphenylether, diaminodiphenylmethane or ring-substituted dianilines, such as Lonzacure® M-DEA, Lonzacure® M-DIPA, Lonzacure® M-MIPA, Lonzacure® DETDA 80 (all of the aforementioned compounds are available from Lonza, Basel, Switzerland).

Preferably, dicyandiamide or modified dicyandiamide is employed.

In the resin composition of the invention, the hardeners or initiators are used in an amount of below 10 wt.-%, preferably below 5 wt.-% (lower limit: about 0.1 wt.-%).

Preferred initiators are imidazoles and derivatives thereof, such as 2-methylimidazole, 2-ethyl-4-methylimidazole, 2-phenylimidazole, 2-phenyl-4-methylimidazole, bis(2-ethyl-4-methylimidazole), 2-undecylimidazole, 2,4-diamino-6(2′-methyl-imidazole(1′))ethyl-s-triazine and 1-cyanoethyl-2-undecylimidazole. Furthermore salts formed from imidazoles and carboxylic acids can be used. Further initiators are 1,8-diaza-bicyclo(5.4.0)undecene (DBU) and boron-trihalide-amine complexes, such as BF3-amine. Further examples may be found in Clayton A. May (Ed.) Epoxy Resins: Chemistry and Technology, 2nd ed., Marcel Dekker Inc., New York, 1988.

The resin composition of the invention further comprises coating additives as component (c). These comprise flow-control agents, degassing agents and lubricants. These are known per se to the skilled person. Typical examples are butyl acrylate polymers as flow-control agents, benzoin as degassing agents and waxes as lubricants. Furthermore, for example stabilizers can be used as coating additives.

The resin composition of the invention contains the coating additives in an amount of generally 0.1-10 wt.-%, preferably 0.2-5 wt.-%.

Coating additives also comprise adhesion promoters. These are useful for providing adhesion to the copper substrate.

The powder coating of the invention may further comprise organic and inorganic fillers (d).

These fillers are suitably employed in the powder coating of the invention in an amount of 5 to 300 wt.-%, preferably 10 to 200 wt.-%, more preferably 10 to 100 wt.-%. The stated amounts relate to the sum of components (a), (b) and (c) of the powder coating.

Examples for organic fillers are fluorine containing polymers, such as polytetra-fluoroethylene (PTFE), tetrafluoroethylene/hexafluoropropylene copolymer (FEP), tetrafluoroethylene/ethylene copolymer (E/TFE), tetrafluoroethylene/hexafluoro-propylene/vinylidene fluoride terpolymer (THV), poly(trifluorochloroethylene) (PCTFE), trifluorochloroethylene/ethylene copolymer (E/CTFE), poly(vinyl fluoride) (PVF), poly(vinylidene fluoride) (PVDF), perfluoroalkoxy copolymer (PFA), tetra-fluoroethylene/perfluoromethylvinylether copolymer (MFA), furthermore poly(vinyl chloride) (PVC), polyphenyl ether (PPO), polysulfone (PSU), polyaryl ether sulfon (PES), polyphenyl ether sulfon (PPSU), polyphenylene sulfide (PPS), polyether ketone (PEK) and polyether imide (PEI).

Especially preferred organic fillers are tetrafluoroethylene/hexafluoropropylene copolymer (FEP), ethylenetetrafluoroethylene copolymer (ETFE) and polyphenyl ether (PPO).

In the powder coating of the invention, there may preferably be used organic fillers which do not melt upon processing. Alternatively, there can be used fillers which melt and show phase separation upon cooling.

Apart from the organic fillers, inorganic fillers may also be used in the powder coating of the invention.

Such fillers are, for example, fused silica, such as Silbond 800 EST, Silbond 800 AST, Silbond 800 TST, Silbond 800 VST, Silbond 600 EST, Silbond 600 AST, Silbond 600 TST, Silbond 600 VST (available from Quarzwerke Frechen, Germany), fumed silica, such as Aerosil 300 and Aerosil R 972, precipitated silica, such as Ultrasil 360, Sipernat D 10, Sipernat 320 (available from Degussa, Germany), calcined kaoline, such as PoleStar (Imerys, St Austell, UK), Santintone (Engelhard Corporation, Iselin, N.J., US), aluminium oxide, magnesium oxide, zirconium oxide, aluminium silicates, calcium carbonate and barium sulfate, silica glass and kaoline being preferred fillers. Furthermore, there may be mentioned ceramics; especially those with low or negative coefficients of expansion.

The advantages of the powder coating of the invention are that it is possible, in order to optimise the properties of the product, to select from a variety of fillers the one which best satisfies the relevant requirements. For example, a given epoxy resin mixture can, thus, be modified as needed. Even fillers which are difficult to process can be incorporated without problems. Thus, electric properties such as the dielectric constant (Dₖ), the dielectric loss factor (tan δ), the breakdown resistance, the surface resistance, the volume resistance and mechanical properties such as bending strength, impact strength, tensile strength as well as further material properties such as the coefficient of thermal expansion (CTE), flammability and others can be adapted as desired. The filler does not have to be solvable or stably dispersable in organic solvents. Consequently, it is possible to use materials as fillers which could previously not or only hardly be used in sequential build-up (SBU), such as the aforementioned organic fillers.

The electrical and mechanical properties of the powder coating and of the coating layer prepared therefrom can be influenced and controlled by the fillers.

Thus, for example fillers with a low dielectric constant, such as PTFE, FEP and kaoline may be employed in order to prepare coating layers with a correspondingly low dielectric constant.

Further electrical properties can be controlled in an analogous way.

The mechanical properties which can be influenced by the fillers comprise, in particular, properties such as the coefficient of thermal expansion, impact strength, and tensile strength.

The following fillers are particularly suitable for controlling the coefficient of thermal expansion: silica glass, kaoline, calcium carbonate and ceramics with a negative coefficient of expansion.

Bending strength can be influenced or controlled, for example, by PPO.

According to a preferred embodiment of the invention, the cured powder coating has a coefficient of thermal expansion (CTE) of <70 ppm/° C. and preferably <60 ppm/° C. in the x-, y- and z-direction.

According to a further preferred embodiment, the dielectric constant of the coating in the cured state is <3.8, preferably <3.6. Moreover, glass transition temperatures of the cured formulation of above 150° C., preferably above 160° C., are preferred.

Furthermore, flame-retardant materials may be used as fillers. Examples for these are inorganic materials which release water upon heating, such as aluminium hydroxide, which is available, for example, as Martinal OL-104, Martinal OL-111 (Martinswerk GmbH, Bergheim, Germany) or Apyral 60 D (Nabaltec, Schwandorf, Germany), magnesium hydroxide, available, for example, as magnesium hydroxide 8814 (Martinswek GmbH, Bergheim, Germany) or Mg-hydroxide SIM 2.2 (Scheruhn Industrie-Mineralien, Hof, Germany), phosphorous-containing organic compounds, such as triphenyl phosphate (TPP), tricresyl phosphate (TCP), cresyl diphenyl phosphate (CDP), tertiary phosphin oxides, such as Cyagard® and Reoflam® 410, red phosphorous in the form of a dispersion in an epoxy resin, such as Exolit RP 650, or in the form of a powder, such as Exolit OP 930 (both products are available from Clariant GmbH, Frankfurt, Germany) and antimony trioxide.

Furthermore, the flammability of the powder coating of the invention can be influenced and controlled by component (c), i.e., the coating additives. In this connection, for example, phosphorous-containing and nitrogen-containing flame retardants may be mentioned.

The powder coating of the invention can, optionally, further contain compatibelizing polymers. Such competibilizing polymers are, for example, di- or triblock co-polymers such as styrene/butadiene/styrene or styrene/butadiene/methyl meth-acrylate blockcopolymers (Atofina, France).

Furthermore, the powder coating of the invention can contain conventional additives which are conventionally used in the processing of epoxy resins.

In the preparation of the powder coating of the invention, the components (a), (b), (c) and, optionally, (d) and (e) are first dry-milled to give a powder.

In doing so, It may be useful to mix and extrude individual components beforehand to prepare a master batch.

This procedure must be used, in particular, when certain components are difficult to incorporate. These are then incorporated into each other beforehand. Such master batches are also commercially available. For example, in the case of the resins, for example, it is possible to mix two resins beforehand. This course of action is used, in particular, when one of the resins has a low glass transition temperature. Moreover, this procedure may be used when certain components are used only in small amounts.

The aforementioned components or master batches are premixed and milled in the dry state. Before milling, the mixture may optionally be cooled.

After thorough mixing (and optional cooling), the material is milled in the dry state while maintaining a powder and the powder is subsequently extruded. This extrusion provides complete homogenisation of the components and is a key step in the overall process.

After extrusion, the material is milled in the dry state and the oversize material is separated, wherein a sieve size in the range of less than 10 to 500 μm and preferably less than 100 μm is suitably used, which guarantees a corresponding particle size. Classifying mills such as Hosekawa MicroPul are particularly suitable for milling.

The aforementioned melt extrusion is preferably carried out in such a way that the conversion of the reactive component is less than 20%, preferably less than 10%. This reaction is due to the fact that a melt is formed upon extrusion. The degree of conversion can be determined by the skilled person by thermal analysis. The corresponding extrusion parameters (for obtaining such a degree of conversion) can be determined by the skilled person by simple experiments. They depend on the type of extruder and the type and amount of the components employed. For example, a Buss co-kneader can be used as extruder, in which the aforementioned components are extruded. As mentioned above, the mass is subsequently cooled and reduced to small pieces. The final powder coating mixtures preferably have an average particle size in the range of 1 to 500 μm, especially of 10 to 100 μm.

The powder coating thus prepared is used according to the invention for the preparation of coating layers on substrates which are subsequently employed in the manufacture of printed circuit boards.

The invention further provides a process for preparing coating layers on substrates, comprising the following steps:

(i) applying the powder coating of the invention to a substrate,

(ii) melting the powder coating and

(iii) curing the powder coating.

In the process of the invention, thin dielectric coating layers, i.e., layers with a thickness of about 5 to 500 μm, are prepared. Therefore, the process of the invention may be used in the manufacture of printed circuit boards and, in particular, in the so-called sequential-build-up process (SBU). Other possible uses are in the application of solder stop masks and in all other processes in which the preparation of thin layers is required and which are characterized in that fillers are used which are not or only poorly soluble in common solvents under normal process conditions.

The powder coating can be applied to the substrate by various methods. Thus, the application of the powder coating can be effected, for example, by spraying, electromagnetic brush coating, powder cloud coating or roller coating.

The spraying can be carried out, for example, by coronar charging or triboelectric charging. These processes are known to the person skilled in the art. Triboelectric charging is preferably used in the process of the invention.

Furthermore, in the process of the invention, the powder coating can be applied by means of rollers. In this case, the powder is applied to the substrate by means of a sieve and subsequently treated with a roller. The roller can be heated.

The application by means of the electromagnetic brush technology is described in WO 96/15199.

The powder cloud technology is described, for example, in Proceedings—International Conference in Organic Coatings: Waterborne, High Solids, Powder Coatings, 23rd, Athens, Jul. 7-11, 1997 (1997), 139-150 Publisher: Institute of Materials Science, New Paltz, N. Y.; Journal für Oberflächentechnik (1996), 36(8), 34-36, 39; Deutsche Forschungsgesellschaft für Oberflächenbehandlung (2000), 44 (Pulverlack-Praxis), 95-100; Journal für Oberflächentechnik (1998), 38(2), 14-18 and in WO 97/47400.

The following methods are, in principle, suitable for melting the powder coating layer:

a) melting in an oven with or without convection,

b) infrared radiation,

c) near infrared (NIR) and

d) induction and optionally

e) excitation by microwaves.

In the process of the invention, the melting is preferably be effected by NIR. This method is described in WO 99/47276, DE 10109847, in Kunststoffe (1999), 89 (6), 62-64 and in Journal für Oberflächentechnik (1998), 38 (2), 26-29.

The step of melting is particularly important. Upon melting, a change in viscosity occurs, i.e., the powder first melts. The viscosity of the melt decreases. Subsequently, curing and, thus, a rise in viscosity takes place. This operation must be conducted in the process of the invention in such a way that the viscosity of the melt is initially as low as possible and subsequently good flow is achieved without formation of bubbles, such that a non-porous film is obtained.

An essential advantage of the process of the invention is to be seen in the fact that the coating layer is first melted, remains flowable and can, thus, be used for the preparation of a multilayer structure.

The invention further provides a process of the preparation of a multilayer structure comprising the following steps:

(i) applying the powder coating of the invention to a substrate,

(ii) melting the powder coating followed by cooling,

(iii) laminating the coated substrate to a printed circuit board which may already comprise more than one layer,

(iv) curing,

(v) drilling and through-connecting the individual layers and substrates to prepare a multilayer structure,

(vi) optionally repeating steps (i) to (v).

In this process, the powder coating is preferably applied by the aforementioned electromagnetic brush technology (EMB). In this way, a more homogeneous application of the powder and, thus, a more homogeneous layer thickness may be achieved. The melting is preferably effected by the NIR method. In this way, pore-free coating layers are obtained.

It is an important feature of this process that the curing takes place only in step (iv), i.e., after formation of the multilayer structure. In this connection, it is important that the films are still flowable during the preparation of the structure.

The curing of the melted powder coated layers takes place during pressing or lamination. The pressing or lamination takes place under vacuum and pressure, the corresponding parameters being known to the skilled person. For example, a Lauffer press or an Adara press can be used. The pressing cycles are to be adapted to the individual material used.

In the last step of this process, the press contacting of the individual layers and substrates takes place in order to prepare the multilayer structure.

Typical substrates are, in particular, copper sheets or polymeric support sheets. These may further be combined with woven or non-woven fabrics of glass fibre or aramide fibre.

When structured substrates are used, the process of the invention comprises the following steps:

(i) applying the powder coating of the invention to the structured substrate,

(ii) melting and curing the powder coating layer followed by cooling,

(iii) drilling,

(iv) metallizing,

(v) optionally repeating steps (i) to (iv).

In this process, the powder coating is preferably applied by the aforementioned electromagnetic brush technology (EMB). In this way, a more homogeneous application of the application and, thus, a more homogeneous layer thickness and better edge coverage can be achieved.

The invention further provides a process for the preparation of coating layers on substrates comprising the following steps:

(i) wet milling the powder coating of the invention, optionally with further additives to prepare a dispersion,

(ii) applying the dispersion to the substrate and

(iii) heat treating the coated substrate.

In the first step of the process of the invention, a dispersion is prepared from the powder coating by addition of water. The solids content of the dispersion is generally 20 to 70 wt.-%, preferably 30 to 60 wt.-%.

In order to prepare the dispersion, the powder is milled with water, optionally adding further additives. In addition to the aforementioned additives, which may be employed in an amount of 0.1 to 5%, preferably 0.5 to 2.5 wt.-%, wetting agents, dispersants, antifoaming agents and degassing agents as well as flow-control agents may be added.

Examples for such wetting agents and dispersants are solutions of high molecular weight block copolymers containing groups with pigment affinity, such as Disperbyk 160, 170 or 182, acrylate copolymers containing groups with pigment affinity, such as Disperbyk 116, solutions of alkylammonium salts, such as Disperbyk 140, solutions of salts of unsaturated polyamino amides and of acidic or polar esters, such as Anti Terra U or Disperbyk 101 (all from Byk Chemie, Wesel, Germany), polycarboxylic acid polymers with or without polysiloxane copolymer such as Byk P 104 or Byk 220 S, fluorine-containing wetting agents such as Zonyl FSN or Zonyl FSH (both from DuPont) and non-ionic surfactants such as products of the Surfynol series from Air Product, Utrecht, NL.

Examples for antifoaming agents and degassing agents are silicone-free foam-destroying polymers, such as Byk 051, solutions or emulsions of foam-destroying polysiloxanes, such as Byk 020 or Byk 067, silicone-free foam-destroying polymers and hydrophobic solids, such as Byk 011, emulsions and mixtures of paraffin base mineral oils and hydrophobic components, such as Byk 033 or Byk 036 (all from Byk Chemie, Wesel, Germany).

Examples for flow-control agents are polyether-modified polydimethyl siloxanes, such as Byk 300 or Byk 085, modified, hydroxyfunctional polydimethylsiloxanes, such as Byk 370, polyether-modified polydimethylsiloxanes, such as Byk 345 and ionogenic and non-ionogenic polyacrylate copolymers, such as Byk 380.

Further examples for additives may be found in WO 96/32452, WO 96/37561, WO 97/01609, WO 97/17390, WO 99/15593, EP 0 714 958 A2 and EP 0 044 810 A1.

The process of the invention has the advantage that the fillers are located in the coating particles and, therefore, no demixing occurs because the filler has been incorporated into the coating particles, which is not soluble in water. This is a particular advantage of the process of the invention: Upon processing the solvent containing formulations known in the prior art, either the filler sediments or must be stabilized by talking special measures, i.e., different filler concentrations occur within the formulations.

In the process of the invention, insoluble coating particles are used which contain the filler homogeneously dispersed therein and, therefore, no concentration differences occur.

In order to be able to obtain a stable dispersion, the particles must have an average size which is smaller than 10 μm, preferably smaller than 7 μm. The particle size can be determined by means of a Coulter counter.

After applying the dispersion to the substrate, a heat treatment takes place which serves to remove the dispersion medium and to melt the powder coating layer. The heat treatment can be carried out such that, after applying the dispersion to the substrate, the film is first dried and melted and subsequently cured. Alternatively, only a single step of drying, melting and curing the powder coating can be carried out after applying the dispersion to the substrate.

The aforementioned methods are suitable for the heat treatment and, in particular, the melting of the coating layer.

Furthermore, the invention provides a process for preparing a multilayer structure, comprising the following steps:
(i) wet milling the powder coating of the invention, optionally with further additives to prepare a dispersion,
(ii) applying the dispersion to a structured substrate,
(iii) heat treating the coated substrate,
(iv) drilling, metallizing and structuring,
(v) optionally repeating the steps (ii) to (iv).

In summary, it may be noted that the powder coating of the invention and the process of the invention provide a possibility to prepare coating layers on substrates, in particular, printed circuit boards, without requiring any organic solvent.

The absence of any organic solvent is an important aspect in view of industrial safety and the resulting air venting systems, waste disposal, environmental protection requirements becoming constantly stricter and the costs associated with these factors.

An important advantage of the described process in industrial practice is the fact that the material to be applied is a one-component system, i.e., the binder (epoxy resin) and the hardener are already present in the actual composition and do not have to be mixed immediately before application.

A further advantage compared to dry films is the storage stability at normal temperatures of transport and storage. The term “storage stable” refers to a resin composition whose components do not react and, in particular, a composition whose exotherm does not decrease by more than 10% over a period of about three months (upon storage at 25° C.).

The invention is illustrated in more detail by the following examples.

### EXAMPLE 1

4444 g D. E. R. 6508 (Dow Chemicals) were melted in an oven at 110° C. After addition of 1460 g melted Primaset BA-200 (Lonza) and 74 g bisphenol A (Aldrich), 60 g Modarez and 12 g benzoin (Aldrich), the mixture was mixed thoroughly. After cooling with liquid nitrogen, the material was milled in a dry state and extruded (twin-screw extruder EBVP from OMC: 110-120° C., 500 rpm).

The powder had a glass transition temperature of 45° C. (DSC).

After repeated dry milling and sieving (100 μm), the powder was applied to a copper sheet in a thickness of 32 μm by means of an EMB machine (Epping). After melting at 160° C. over 5 min, the powder showed excellent flow. The film is free of bubbles.

After thermal curing at 190° C. for 20 minutes, the layer thickness of the dielectric was determined to be 45 μm. The T_{g} (DSC) was 172° C.

### EXAMPLE 2

290 g DER 6508, 58 g NC 7000-L, 58 g BADCy, 11.7 g DICY, 180 g Silbond EST 800 and 0.6 g phenylimidazole were mixed in a premixer and subsequenetly extruded (twin-screw extruder EBVP from OMC: 110-120° C., 500 rpm). After dry milling and sieving, a part of the powder was cured and the coefficient of expansion was measured by TMA (CTE=55 ppm, Dk (at 1 GHz)=3.6).

### EXAMPLE 3

350 g DER 6508, 70 g NC 7000-L, 202 g Silbond EST 800 and 50 g ETFE ET 6235 were thoroughly mixed in a premixer and extruded at 260° C. The material was milled and sieved and mixed with 70 g Primaset BA-200, 14 g DICY, 0.7 g phenyimidazole, 1.5 g benzoin and 11.4 g Modarez and then extruded at 130° C. (twin-screw extruder EBVP from OMC: 110-120° C., 500 rpm). After milling and sieving, the powder was applied to a copper sheet by means of an EMB machine (Epping) and cured at 190° C. Dk (at 1 GHz)=3.3.

### EXAMPLE 4

The powder of Example 1, after dry milling, was sieved through a 100 μm sieve. 250 g of this powder were stirred and mixed with 374 g demineralised water, 0.37 g Surfynol 440, 2.77 g Disperbyk 185 and 4.16 g antifoaming agent Byk 028. This dispersion was milled twice in a DynoMill (Bachofen, Basel, CH) (grinding material ZrO₂, diameter 0.8 mm; gap width 0.3 mm; motor speed 10 m/s). Then 124 g powder, 0.185 g Surfynol 440, 0.277 g Disperbyk 185, 0.369 g Byk 028 and 0.28 g Aerosil R 972 were again added and the mixture was again milled twice as described above. The highly viscous material was slowly stirred over night in order to allow the obtained foam to disappear. The suspension thus obtained (which had become less viscous) was again mixed with 0.28 g Aerosil and then applied to a copper-clad FR-4 laminate by means of a doctor knife and cured in an oven at 190° C. The layer thickness was determined by means of a layer thickness measuring device (Isoscope, Fischer) to be 45 μm. The coating layer was smooth and pore-free and had a glass transition temperature (Tg) of 165° C.

### COMPARATIVE EXAMPLE 1

43.7 g D. E. R. 6508 (Dow Chemicals) was dissolved with 14.4 g Primaset BA-200 (Lonza), 0.73 g bisphenol A (Aldrich), 0.59 g Modarez and 0.12 g benzoin in 150 ml MPA. After addition of 5.5 g poly(tetrafluoroethylene) (Ausimont) a white solid floats on the surface so that this mixture cannot be applied.

### COMPARATIVE EXAMPLE 2

The powder of Example 3 was suspended in MPA. The material formed a viscous mass which deposited at the bottom of the vessel and could not be applied to a copper sheet.

1. Curable powder coating having a glass transition temperature of at least 150° C. in the cured state obtainable by
(i) mixing
(a) a polymeric binder and at least one of an oxazine resin, a cyanate ester or a maleimide,
(b) a hardener or initiator,
(c) a coating additive,
(d) optionally a filler,
(e) optionally a compatibilizing polymer and optionally further components
(ii) melt extruding the mixture obtained in step (i) and
(iii) milling and sieving the extruded mixture.

2. Powder coating according to claim 1, wherein the powder coating has a glass transition temperature in the uncured state of at least 20° C., and has a glass transition temperature in the cured state of at least 160° C.

3. Powder coating according to claim 1, wherein the polymeric binder is a solid epoxy resin.

4. Powder coating according to claim 1 wherein the component (a) comprises a mixture of epoxy resins with a glass transition temperature of at least 20° C.

5. Powder coating according to claim 1, wherein the epoxy resin is selected from the group consisting of standard solid epoxy resins based on bisphenol A and bisphenol A diglycidyl ether.

6. Powder coating according to claim 5, wherein the epoxy equivalent weight of the epoxy resin is >300 g/equivalent.

7. Powder coating according to claim 1, wherein the epoxy resin contains a multifunctional epoxy resin or a mixture of multifunctional epoxy resins.

8. Powder coating according to claim 7, wherein the multifunctional epoxy resin is selected from the group consisting of cresol-novolak epoxy resins, phenol-novolak epoxy resins and naphthol-containing multifunctional epoxy resins.

9. Powder coating according to claim 1, wherein the cyanate ester is selected from the group consisting of bifunctional and multifunctional cyanate esters.

10. Powder coating according to claim 1, wherein the maleimide is selected from the group consisting of bifunctional and multifunctional maleimides and the oxazine resin is selected from the group consisting of bifunctional and multifunctional oxazine resins.

11. Powder coating according to claim 1, wherein the hardener is selected from the group consisting of phenolic hardeners, bisphenol A, dicyandiamide or modified dicyandiamide, acid anhydrides, aromatic and aliphatic amines and ring-substituted diamines.

12. Powder coating according to claim 11, wherein the hardener is dicyandiamide or a modified dicyanamide.

13. Powder coating according to claim 1 wherein the hardener or initiator is in an amount of 0.1 to 10 wt.-%.

14. Powder coating according to claim 1, wherein the coating additives are in an amount of 0.1 to 10 wt.-%.

15. Powder coating according to claim 1, wherein the filler is in an amount of 5 to 300 wt. %, based on components (a), (b) and (c).

16. Powder coating according to claim 1 wherein the filler is an inorganic filler.

17. Powder coating according to claim 16, wherein the filler is fused silica or kaoline.

18. Powder coating according to claim 1 wherein the filler has an average particle size of less than 30 μm.

19. Powder coating according to claim 1 wherein the filler is an organic filler which does not melt upon processing of the powder coating.

20. Powder coating according to claim 1 wherein the filler is an organic filler which melts upon processing of the powder coating and shows phase separation upon cooling.

21. Powder coating according to claim 1 wherein the filler is polyphenyl ether or a fluorinated thermoplastic.

22. Powder coating according to claim 1, wherein the powder coating's coefficient of thermal expansion in the hardened state is <70 ppm/° C., in the x-, y- and z-direction.

23. Powder coating according to claim 1, wherein the powder coating's dielectric constant in the hardened state is <3.8.

24. Powder coating according to claim 1, wherein the powder coating is stable in storage, and wherein its exotherm does not decrease by more than 10% upon storage for three months at 25° C.

25. Powder coating according to claim 1, comprising as component (a) about 50-90 wt.-% of epoxide and about 5-20 wt.-% of cyanate ester, as component (b) about 0.5-5 wt.% dicyandiamide and about 0.1-2 wt.-% of 2-phenylimidazole.

26. Process for the preparation of the curable powder coating according to claim 1, comprising the following steps:
(i) mixing of components (a), (b), (c) and optionally (d) and (e),
(ii) melt extrusion of the mixture obtained in step (i) and
(iii) milling and sieving of the extruded mixture.

27. Process according to claim 26, wherein two or more of the components (a), (b), (c), (d) and (e) are used as a master batch in step (i).

28. Process according to claim 26 wherein step (ii) is carried out such that the conversion of the reactive component is less than 20%.

29. Process for the preparation of coating layers on substrates comprising the following steps:
(i) wet milling of the powder coating according to claim 1, optionally with further additives to prepare a dispersion,
(ii) applying the dispersion to the substrate and
(iii) heat treating the coated substrate.

30. Process according to claim 29, wherein the heat treatment in step (iii) is carried out such that, after applying the dispersion to the substrate, the film is first dried and melted and subsequently cured.

31. Process according to claim 29, wherein the heat treatment of the coated substrate in step (iii) is carried out such that, after applying the dispersion to the substrate, a single step of drying, melting and curing the powder coating is carried out.

32. Process for preparing a multilayer structure comprising the following steps:
(i) wet milling of the powder coating according to claim 1, optionally with further additives to prepare a dispersion,
(ii) applying the dispersion to a structured substrate,
(iii) heat treating the coated substrate,
(iv) drilling and metallizing,
(v) optionally repeating steps (ii) and (iv).

33. Process according to claim 29 wherein the substrate is a copper sheet, a polymeric support sheet, a structured printed circuit board or a core layer thereof.

34. Process according to claim 33, wherein the support sheet is combined with woven or non-woven fabric of glass fibre or aramide fibre.

35. Process according to claim 29 wherein antifoaming agents, wetting agents, biocides, rheologic additives or flow-control agents are used as additives.

36. Process according to claim 29 wherein the heat treatment or the curing is effected by
(a) melting in an oven with or without convection,
(b) infrared radiation,
(c) near infrared radiation (NIR),
(d) induction or
(e) excitation by microwaves.

37. Process for preparing coating layers on substrates comprising the following steps:
(i) applying the powder coating according to claim 1 to a substrate,
(ii) melting the powder coating and
(iii) curing the powder coating.

38. Process for preparing a multilayer structure comprising the following steps:
(i) applying the powder coating according to claim 1 to the substrate,
(ii) melting the powder coating followed by cooling,
(iii) laminating the coated substrate to a printed circuit board which may already comprise more than one layer,
(iv) curing,
(v) drilling and through-connecting the individual layers and substrates to prepare a multilayer structure,
(vi) optionally repeating steps (i) to (v).

39. Process according to claim 37 wherein the substrate is a copper sheet or a polymeric support sheet.

40. Process according to claim 39, wherein the support sheets are combined with woven or non-woven fabric of glass fibre or aramide fibre.

41. Process for the preparation of a multilayer structure comprising the following steps:
(i) applying the powder coating according to claim 1 to a structured substrate,
(ii) melting and curing the powder coating layer followed by cooling,
(iii) drilling,
(iv) metallizing,
(v) optionally repeating steps (i) to (iv).

42. Process according to claim 37 wherein the application of the powder coating is effected by spraying, electromagnetic brush coating, powder cloud coating or roller coating.

43. Process according to claim 42, wherein the spraying is effected by coronar charging or triboelectric charging.

44. Process according to claim 37 wherein the melting is effected by
(a) melting in an oven with or without convection,
(b) infrared radiation,
(c) near infrared radiation (NIR),
(d) induction or
(e) excitation by microwaves.

45. Process according to claim 32, wherein the substrate is a copper sheet, a polymeric support sheet, a structured printed circuit board or a core layer thereof.

46. Process according to claim 45, wherein the support sheet is combined with woven or non-woven fabric of glass fibre or aramide fibre.

47. Process according to claim 32, wherein antifoaming agents, wetting agents, biocides, rheologic additives or flow-control agents are used as additives.

48. Process according to claim 32, wherein the heat treatment or the curing is effected by
(a) melting in an oven with or without convection,
(b) infrared radiation,
(c) near infrared radiation (NIR),
(d) induction or
(e) excitation by microwaves.

49. Process according to claim 38, wherein the substrate is a copper sheet or a polymeric support sheet.

50. Process according to claim 49, wherein the support sheets are combined with woven or non-woven fabric of glass fibre or aramide fibre.

51. Process according to claim 41, wherein the application of the powder coating is effected by spraying, electromagnetic brush coating, powder cloud coating or roller coating.

52. Process according to claim 51, wherein the spraying is effected by coronar charging or triboelectric charging.

53. Process according to claim 41, wherein the melting is effected by
(a) melting in an oven with or without convection,
(b) infrared radiation,
(c) near infrared radiation (NIR),
(d) induction or
(e) excitation by microwaves.
